(19) United States
(12) Patent Application Publication
(10) Pub. No.: US 2020/0036714 A1
(43) Pub. Date: Jan. 30, 2020

(54) METHOD, SYSTEM, SERVER, AND TERMINAL FOR IDENTITY AUTHENTICATION

(71) Applicant: SZ DJI TECHNOLOGY CO., LTD., Shenzhen (CN)

(72) Inventors: Yongsen CHEN, Shenzhen (CN); Zhun DING, Shenzhen (CN); Ming CHEN, Shenzhen (CN); Ming GONG, Shenzhen (CN)

(21) Appl. No.: 16/589,829

(22) Filed: Oct. 1, 2019

Related U.S. Application Data
(63) Continuation of application No. PCT/CN2017/079351, filed on Apr. 1, 2017.

(51) Int. Cl. H04L 29/06

(52) U.S. Cl. CPC H04L 63/0884; H04L 63/0428; H04L 63/0853

(57) ABSTRACT

The present disclosure provides an identify authentication system. The authentication system includes an authentication terminal configured to issue an identity authentication request; and, an authentication server that is connected to the authentication terminal to receive the identity authentication request. The authentication server is configured to acquire one or more identity authentication scenarios from authentication scenarios based on the identity authentication request, and generate and transmit an authentication form after acquiring the authentication scenario. The authentication terminal is configured to submit the identity authentication information to the authentication server based on the authentication form. The identity authentication information includes basic user information and an authentication scenario image and video including a user. The authentication server is further configured to authenticate the user's identity based on the identity authentication information.

### CROSS-REFERENCE TO RELATED APPLICATION

This application is a continuation application of International Application No. PCT/CN2017/079351, filed on Apr. 1, 2017, the entire contents of which are incorporated herein by reference.

### TECHNICAL FIELD

The present disclosure relates to the field of user identity authentication technology, more specifically, to a method, system, server, and terminal for identity authentication.

### BACKGROUND

User identity authentication is widely used in various occasions and fields, such as banking, security, and various software applications, and conventional authentication technologies are generally based on the following technologies.

Counter authentication: a user brings an identification document to a counter for authentication, and the information is entered by an authentication agency. This is similar to a resident information collection system, which is highly secure, but the operation is complex, and the cost is high.

Remote automatic authentication: a user submits personal identification information (such as name, ID card, mobile phone number, or email) to a remote authentication server, then the authentication server checks the consistency of the information submitted by the user. This method can be used to perform identity authentication, but there is no way to prevent a user from submitting another user's information for authentication. Such as the following websites: http://www.apix.cn/services/show/159 and http://q.id5.cn/sft/13.html.

Remote human authentication: on the basis of submitting personal identification information, a user may further provide some personal pictures, videos, etc. (such as a photo of the user taken with the identification document) to help with the authentication, which will require extensive human involvements.

Biometric authentication: a user's identity may be authenticated by means of fingerprints, human face, etc. This method requires the establishment of a corresponding biometric database in advance and is dependent on a biometric identification algorithm.

Bank card authentication: a third-party financial institution may be used to authenticate a user with a bank card and a password. Since the process of obtaining the bank card will require detailed identity information, it may be convenient to use this information to authenticate the user. Moreover, the authentication of the user's true identity may be more reliable by using the password. However, this method is limited by the user's habits, as it may be difficult to require the user to use the bank card information for identity authentication when no item is being exchanged.

Mobile phone authentication: using a mobile platform, a user's identity may be authenticated by using a mobile phone number and a mobile phone service password. Because of the mobile phone real-name registration system, mobile phone with the real-name registration may have the same level of authentication as the bank card. However, since not everyone will remember the mobile phone service password and the real-name registration of the mobile phone is not as complete as the bank card, the scope of the authentication may be limited.

User behavior authentication: a user's identity and location may be authenticated based on the user's behavior. For example, electronic devices that the user often uses may be used to further enhanced the authentication. However, this method will need to collect and analyze the user's behavior, and a new system will not be able to acquire this type of data.

### SUMMARY

In view of the current identity authentication technologies, the embodiments of the present disclosure provide a method, system, server, and terminal for identity authentication, which may improve the reliability of the authentication without the need for additional platforms.

One aspect of the present disclosure provides an identify authentication system. The authentication system includes an authentication terminal configured to issue an identity authentication request; and, an authentication server that is connected to the authentication terminal to receive the identity authentication request. The authentication server is configured to acquire one or more identity authentication scenarios from authentication scenarios based on the identity authentication request, and generate and transmit an authentication form after acquiring the authentication scenario. The authentication terminal is configured to submit the identity authentication information to the authentication server based on the authentication form. The identity authentication information includes basic user information and an authentication scenario image and video including a user. The authentication server is further configured to authenticate the user's identity based on the identity authentication information.

Another aspect of the present disclosure provides a method for identify authentication. The method includes issuing, by an authentication terminal, an identity authentication request; acquiring, by an authentication server, one or more authentication scenarios from a plurality of authentication scenarios based on the identity authentication information; generating, by the authentication server, an identity authentication form based on the acquired identity authentication scenario; and transmitting, by the authentication server, the generated identity authentication form to the authentication terminal, the identity authentication form including a plurality of fields that include a basic user information field, and one or more acquired authentication scenarios. The method further includes submitting, by the authentication terminal, the identity authentication information to the identity authentication server based on the entity authentication form; and, authenticating, by the identity authentication server, a user based on the identity authentication information to generate an authentication result.

The identity authentication method, system, server, and terminal of the present disclosure may use one or more randomly generated scenarios to improve the reliability of the authentication.

### BRIEF DESCRIPTION OF THE DRAWINGS

FIG. 1 is a structural diagram of an identity authentication system according to an embodiment of the present disclosure;

FIG. 2 is a schematic diagram of an authentication terminal according to an embodiment of the present disclosure;

FIG. 3 is a modular diagram of an authentication server according to an embodiment of the present disclosure;

FIG. 4 is a schematic diagram of an authentication platform according to an embodiment of the present disclosure;

FIG. 5 is a flowchart of an identity authentication method according to an embodiment of the present disclosure;

FIG. 6 is a schematic diagram of an identity authentication scenario according to an embodiment of the present disclosure;

FIG. 7 is a schematic diagram of another identity authentication scenario according to an embodiment of the present disclosure;

FIG. 8 is a schematic diagram of an identity authentication form according to an embodiment of the present disclosure;

FIG. 9 is an identity authentication system according to another embodiment of the present disclosure;

FIG. 10 is a modular diagram of an authentication server according to another embodiment of the present disclosure; and,

FIG. 11 is a flowchart of an identity authentication method according to another embodiment of the present disclosure.

It should be noted that the reference numerals shown in the drawings are described as follows:

| | |
|---|---|
| Identity authentication system | 1, 8 |
| Authentication terminal | 10 |
| Authentication server | 20 |
| Authentication platform | 30 |
| First authentication system | 100 |
| Interface module | 101 |
| First receiving module | 102 |
| First transmission module | 103 |
| First communication unit | 104 |
| First memory | 105 |
| First processor | 106 |
| Display | 107 |
| Input unit | 108 |
| Image acquisition unit | 109 |
| Second authentication system | 200 |
| Second receiving module | 201, 601 |
| Acquisition module | 202, 602 |
| Form generation module | 203, 603 |
| Second transmission module | 204, 604 |
| Submission module | 205 |
| Second communication unit | 206, 606 |
| Third communication unit | 207 |
| Second memory | 208, 608 |
| Second processor | 209, 609 |
| Third authentication system | 300 |
| Third receiving module | 301 |
| Scenario generation module | 302 |
| Scenario transmission module | 303 |
| Authentication module | 304, 605 |
| Authentication result transmission module | 305 |
| Fourth communication unit | 306 |
| Third memory | 307 |
| Third processor | 308 |
| Basic user information | 402 |
| Authentication scenario | 404 |
| Identity authentication process | 500, 700 |

The present disclosure will be further illustrated by the following detailed description in conjunction with the accompanying drawings.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

It should be noted that in the embodiments of the present invention, when a component is described as being “fixed to” another component, it can be directly located on the other component or an intermediate component can also be present. When a component is deemed as being “connected” to another component, it can be directly connected to the component or an intermediate component can also be present at the same time. When a component is deemed as being “arranged” on another component, it can be directly arranged on the other component or an intermediate component can also be present at the same time. The terms “vertical”, “horizontal”, “left”, “right” and similar expressions used in the embodiments of the present disclosure are for illustrative purposes only and are not intended to limit the present disclosure.

Unless defined otherwise, the technique and science terms used in the present disclosure have the same meanings as those understood by the skilled of the technique field of the present disclosure. The terms used herein are merely for describing particular embodiments, but not intended to limit the present disclosure. The term “and/or” used herein means any combination of one or more listed items.

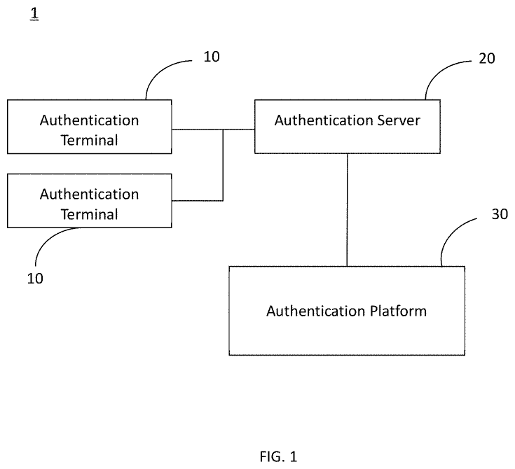

Referring to FIG. 1, the present disclosure provides an identity authentication system 1. The identity authentication system 1 may include, but is not limited to, one or more authentication terminals 10, an authentication server 20, and an authentication platform 30. The authentication terminal 10 may be communicatively connected to the authentication server 20, and the authentication server 20 may be communicatively connected to the authentication platform 30. The authentication terminal may initiate an authentication process based on a user operation, issue an authentication request, receive a user input, and transmit the inputted authentication data to the authentication server 20. The authentication server 20 may obtain an authentication scenario from the authentication platform 30 based on the authentication request, generate an authentication form based on the authentication scenario, and transmit the authentication form to the authentication terminal 10. The authentication terminal 10 may receive the authentication data inputted by the user for the authentication form and transmit the authentication data to the authentication server 20. The authentication server 20 may transmit the authentication data to the authentication platform 30 for authentication. The authentication platform 30 may return an authentication result to the authentication server 20, and the authentication server 20 may forward the authentication result to the authentication terminal 10.

It can be understood that in other embodiments, the authentication server 20 and the authentication platform 30 may be integrated. Further, the authentication server 20 may store a plurality of authentication scenarios, and the authentication scenario generation and the identity authentication may be completed in the authentication server 20.

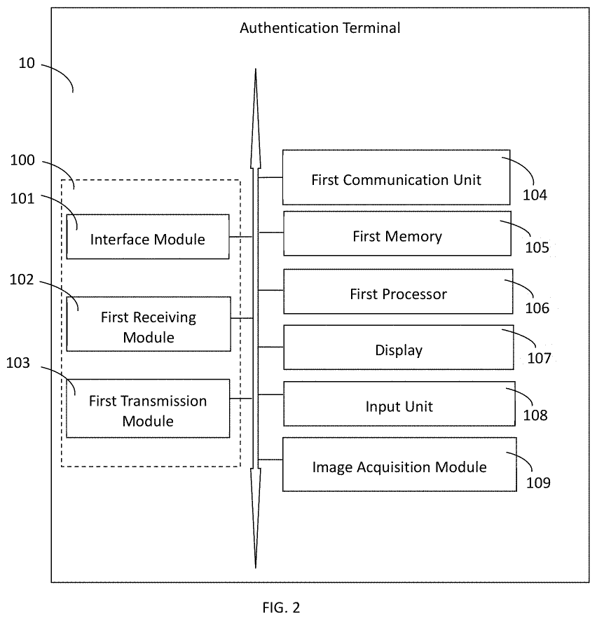

FIG. 2 is a schematic diagram of an authentication terminal according to an embodiment of the present disclosure. The authentication terminal 10 may be a mobile phone, a tablet, a laptop, a desktop, etc. The authentication terminal 10 may include, but is not limited to, a first communication unit 104, a first memory 105, a first processor 106, a display 107, an input unit, and an image acquisition unit 109.

The first communication unit 104 may be in communication with the authentication server 20, and the connection method may be a wired connection or a wireless connection. The wired connection may include a connection through a communication port, such as, a Universal Serial Bus (USB), a controller area network (CAN), a serial and/or other standard network connections, an Inter-Integrated Circuit (I2C) bus, etc. The wireless connection may include any type of wireless communication system, such as Bluetooth, infrared, Wireless Fidelity (Wi-Fi), cellular technology, satellite, and broadcast. The cellular technology may include mobile communication technologies such as 2G, 3G, 4G, or 5G. In particular, the 3G and 4G technologies are mobile communication standards that conform to the international standards issued by the International Telecommunications Union (ITU). Further, the 3G and 4G technologies may provide an information transmission rate of 200 kilobyte per second to several kilobyte per second, making them suitable for transmitting high resolution images and videos with large bandwidth. Furthermore, the 3G technology generally refers to technologies that meet the reliability and data transmission rate of the International Mobile Telecommunications 2000 (IMT-2000) standard. Common commercial 3G technologies may include systems and radio interfaces that are based on the spread spectrum radio transmission technology, such as the UMTS system standardized by the 3^{rd} Generation Partnership Project (3GPP), W-CDMA radio interface, TD-SCDMA radio interface proposed by China, HSPA+UMTS release, CDMA2000 system, and EV-DO. In addition, other technologies such as EDGE, DECT, and mobile WiMAX are also in compliance with IMT-2000 and are therefore are approved by the ITU as 3G standards. Correspondingly, the term “3G” used herein may include, but is not limited to, any IMT-2000 compliant technologies, including those mentioned above.

In contrast, the 4G technology is widely understood as those that conform to the International Mobile Telecommunications Advanced (IMT-Advanced) standard, which requires a maximum speed of 100 megabyte per second for high mobility communications, and 1 gigabyte per second for low mobility communications. In October 2010, the ITU-approved 4G standards included enhanced LTE and enhanced Wireless MAN-Advanced. However, 4G services provided by some commercial operators are not fully compliant with the IMT-Advanced standard such as LTE, Mobile WiMAX, and TD-LTE. The term “4G” mentioned herein may include, but is not limited to, these latter technologies, such as LTE, Mobile WiMAX and TD-LTE, and those that conform to the IMT-Advanced specification, including those mentioned above. In addition, 5G is the next-generation mobile communication standard that surpasses the current 4G/IMT-Advanced standard.

The first memory 105 may be an internal storage of the authentication terminal 10, for example, a hard disk or a memory. Or, the first memory 105 may be a plug-in storage device, such as a plug-in hard disk, a Smart Media Card (SMC), a Secure Digital (SD) card, and a flash card. Further, the first memory 105 may also include both the internal storage unit and the plug-in storage device.

The first processor 106 may be a Central Processing Unit (CPU), a microprocessor, or other data processing chip for performing the functions of the authentication terminal 10.

The display 107 may be a Liquid Crystal Display (LCD), a Light Emitting Diode (LED) display, an Organic Light-Emitting Diode (OLED) display, or other suitable displays.

The input device 108 may be any suitable input device including, but is not limited to, a mouse, a keyboard, a touch screen, or a contactless input, such as a gesture input, a voice input, and the like. The input unit 108 may be used to receive a user input to initiate an authentication process or issue an authentication request.

The image acquisition unit 109 may be used to acquire an image or a video of the scene with the user in it. The image acquisition unit 109 may be integrated with the authentication terminal 10, or it may be a removable image acquisition unit that may be detachably disposed on the authentication terminal 10. It may be understood that in other embodiments, the image acquisition unit 109 may also be a separately image acquisition unit that may be communicably connected to the authentication terminal 10 for transmitting the acquired image or video of the scene to the authentication terminal 10 in a wired or a wireless manner.

A first authentication system 100 may be installed and operated in the authentication terminal 10 and may include computer executable instructions in the form of one or more programs that may be executed by the first processor 106. The first authentication system 100 may also be integrated and fixed in the first processor 106, or it may be stored in the first memory 105 independently of the first processor 106. In the present embodiment, the first authentication system 100 may include, but is not limited to, an interface module 101, a first receiving module 102, and a first transmission module 103. The functional modules in the present disclosure may be referred to as a series of computer executable instructions that may be executed by the first processor 106 of the authentication terminal 10 to perform fixed functions. In particular, the series of computer executable instructions may be stored in the first memory 105.

The interface module 101 may be used to provide a user authentication interface, which may be displayed on the display 107.

The first receiving module 102 may be used to receive the input information from the input unit 107 and the acquired image of the scene from the image acquisition unit 109. The received input information may include, but is not limited to, a user identity authentication information. The user identity authentication information may include, but is not limited to, a name, a gender, an ID card information, an image or video of the scene, a random verification code, etc. Alternatively, the user identity authentication information may further include the user's electronic signature or electronic stamp.

The first transmission module 103 may be used to transmit the user identity authentication information to the authentication server 20 by using the first communication unit 104.

It may be understood that the first authentication system 100 may be installed and executed in the authentication terminal 10 in the form of an application software. In other embodiments, the first authentication system may not be pre-installed on the authentication terminal 10, but the authentication terminal 10 may open a webpage authentication system by accessing a specific website through a web browser, such as Internet Explorer (IE) or Google Chrome.

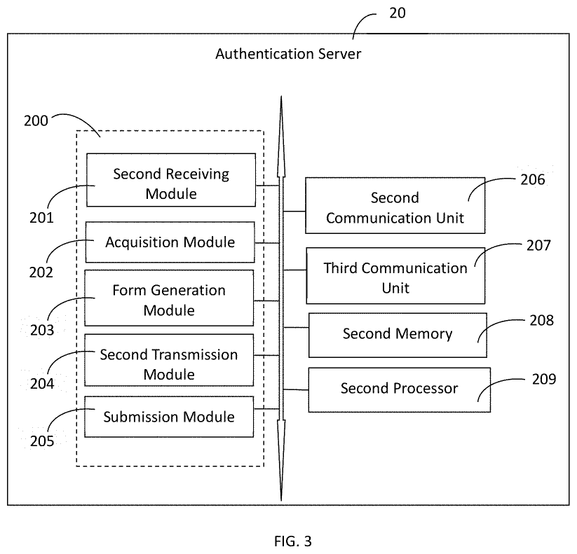

FIG. 3 is a modular diagram of an authentication server 20 according to an embodiment of the present disclosure. The authentication server 20 may include, but is not limited to, a second communication unit 206, a third communication unit 207, a second memory 208, and a second processor 209. The second communication unit 206 may be a communication unit corresponding to the first communication unit 104 and may be a wired or a wireless communication unit. Further, the second communication unit 206 may be communicatively connected to the first communication unit 104 to facilitate communication between the authentication terminal 10 and the authentication server 20.

The third communication unit 207 may be used to communicate with the authentication platform 30, and similar to the second communication unit 206, the third communication unit 207 may also be a wired or a wireless communication unit. The wired connection may include a connection through a communication port, such as, a USB, a CAN, a serial and/or other standard network connections, an I2C bus, etc. The wireless connection may include any type of wireless communication system, such as Bluetooth, infrared, Wi-Fi, cellular technology, satellite, and broadcast. The cellular technology may include mobile communication technologies such as 2G, 3G, 4G, or 5G. It may be understood that, in some embodiments, the third communication unit 207 can be omitted, and the authentication server 20 and the authentication platform 30 may be communicatively connected by the second communication unit 206.

The second memory 208 may be an internal storage of the authentication server 20, for example, a hard disk or a memory. Or, the second memory 208 may be a plug-in storage device, such as a plug-in hard disk, a SMC, a SD card, and a flash card. Further, the second memory 208 may also include both the internal storage unit and the plug-in storage device.

The second processor 209 may be a Central Processing Unit (CPU), a microprocessor, or other data processing chip for performing the functions of the authentication server 20.

A second authentication system 200 may be installed and operated in the authentication server 20 and may include computer executable instructions in the form of one or more programs that may be executable by the second processor 209. The second authentication system 200 may also be integrated and fixed in the second processor 209, or it may be stored in the second memory 208 independently of the second processor 209. In the present embodiment, the second authentication system 200 may include, but is not limited to, a second receiving module 201, an acquisition module 202, a form generation module 203, a second transmission module 204, and a submission module 205. The functional modules in the present disclosure may be referred to as a series of computer executable instructions that may be executed by the second processor 209 of the authentication server 20 to perform fixed functions. In particular, the series of computer executable instructions may be stored in the second memory 208. In addition, the second receiving module 201 may be used to receive the authentication request and the identity authentication information from the authentication terminal 10 by using the second communication unit 206.

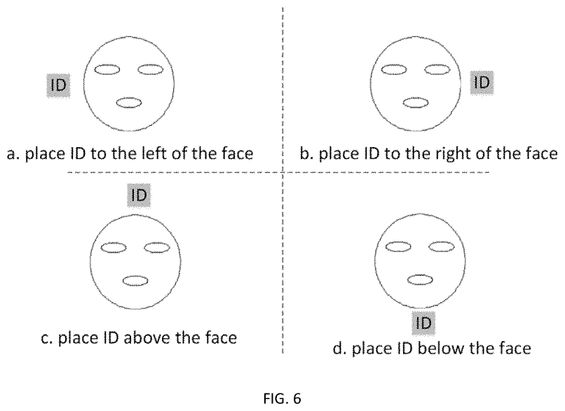

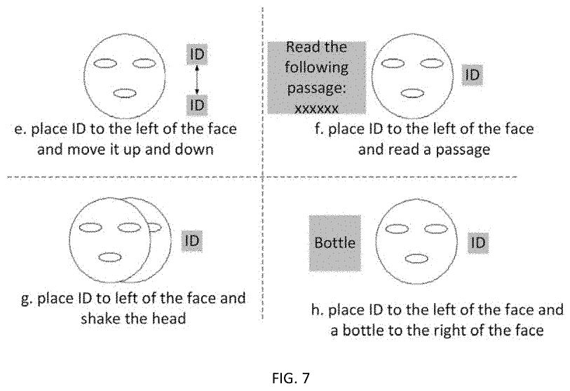

The acquisition module 202 may be used to acquire the authentication scenario from the authentication platform 30 by using the third communication unit 207. For a detailed description of the authentication scenario, reference may be made to the description of FIG. 6 and FIG. 7. The acquisition module 202 may further be used to acquire an authentication result from the authentication platform 30. The authentication result may include a successful authentication result or an unsuccessful authentication result. In some embodiments, the authentication result may further include a description of the reason of the unsuccessful authentication result, such as incorrect ID card information (e.g., an expired ID card) or a mismatch between the identity information and the image of the scene.

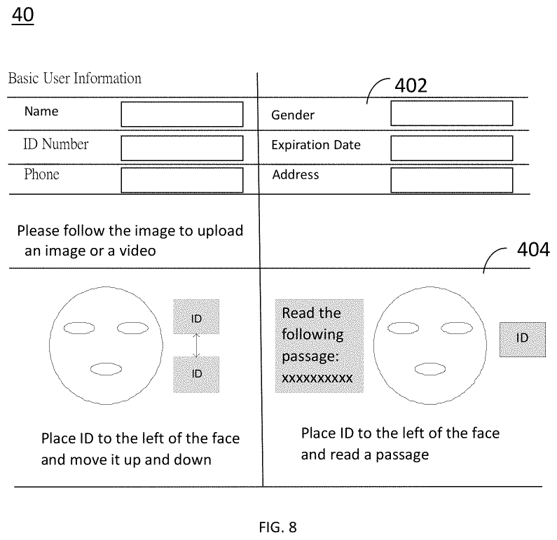

The form generation module 203 may be used to generate an authentication form based on the acquired authentication scenario. The authentication form may include, but is not limited to, one or more authentication scenarios and scenario instances (such as the authentication scenario 404 shown in FIG. 8), where the scenario instances may be an example of an image or a video of a user in the authentication scenario, a basic user information (such as the basic user information 402 in FIG. 8), etc. The basic user information may include, but is not limited to, a name, a gender, and an ID card information.

The second transmission module 204 may be used to transit the generated authentication form to the authentication terminal 10 by using the second communication unit 206. The second transmission module 204 may further be used to transmit the authentication result to the authentication terminal 10 by using the second communication unit 206. In particular, the authentication form and the authentication result may be displayed on the display 107 through the interface module 101 of the authentication terminal 10.

The submission module 205 may be used to submit the user identity authentication information to the authentication platform 30. The user identity authentication information may include the basic user information filled in by the user and a scene image or video including the user.

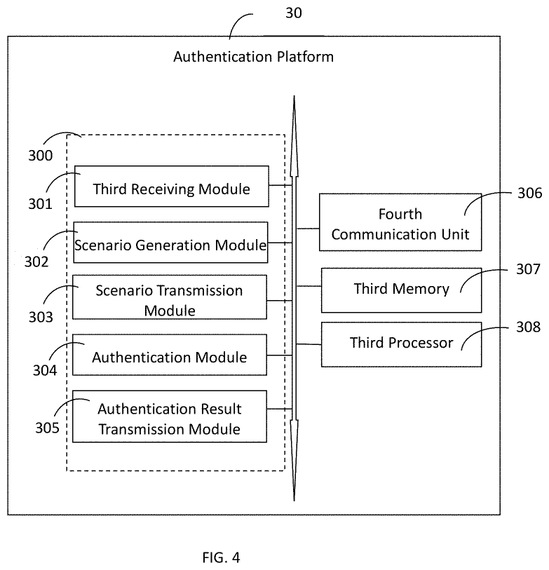

FIG. 4 is a schematic diagram of an authentication platform 30 according to an embodiment of the present disclosure. The authentication platform 30 may include, but is not limited to, a fourth communication unit 306, a third memory 307, and a third processor 308. The fourth communication unit 306 may be a communication unit corresponding to the third communication unit 207 and may include a wired or a wireless communication unit. The fourth communication unit 306 may be in communication with the third communication unit 207 to facilitate the communication between the authentication platform 30 and the authentication server 20. It may be understood that when the third communication unit 207 is omitted, the fourth communication unit 306 may be the communication unit corresponding to the second communication unit 206 and may include a wired and a wireless communication unit. The fourth communication unit 306 may be communicatively connected to the second communication unit 206 to facilitate the communication between the authentication platform 30 and the authentication server 20.

The fourth communication unit 306 may be used to communicate with the authentication platform 30, and similar to the third communication unit 207 or the second communication unit 206, the fourth communication unit 306 may also be a wired or a wireless communication unit. The wired connection may include a connection through a communication port, such as, a USB, a CAN, a serial and/or other standard network connections, an I2C bus, etc. The wireless connection may include any type of wireless communication system, such as Bluetooth, infrared, Wi-Fi, cellular technology, satellite, and broadcast. The cellular technology may include mobile communication technologies such as 2G, 3G, 4G, or 5G.

The third memory 307 may be an internal storage of the authentication platform 30, for example, a hard disk or a memory. Or, the third memory 307 may be a plug-in storage device, such as a plug-in hard disk, a SMC, a SD card, and a flash card. Further, the second memory 208 may also include both the internal storage unit and the plug-in storage device.

The third processor 308 may be a Central Processing Unit (CPU), a microprocessor, or other data processing chip for performing the functions of the authentication platform 30.

A third authentication system 300 may be installed and operated in the authentication platform 30 and may include computer executable instructions in the form of one or more programs that may be executable by the third processor 308. The third authentication system 300 may also be integrated and fixed in the third processor 308, or it may be stored in the third memory 307 independently of the third processor 308. In the present embodiment, the third authentication system 300 may include, but is not limited to, a third receiving module 301, a scenario generation module 302, a scenario transmission module 303, an authentication module 304, and an authentication result transmission module 305. The functional modules in the present disclosure may be referred to as a series of computer executable instructions that may be executed by the third processor 308 of the authentication platform 30 to perform fixed functions. In particular, the series of computer executable instructions may be stored in the third memory 307. In addition, the third receiving module 301 may be used to receive an authentication scenario request by using the fourth communication unit 306. The third receiving unit 301 may be further used to receive the user identity authentication information from the authentication server 20.

The scenario generation module 302 may be used to randomly generate an authentication scenario based on a received authentication scenario acquisition request. More specifically, a plurality of authentication scenarios and authentication scenario instances may be stored in the third memory 307. When the authentication scenario acquisition request is received, the scenario generation module 302 may randomly acquire one or more authentication scenarios from the third memory 307.

The scenario transmission module 303 may be used to transmit the generated authentication scenario to the authentication server 20 by using the fourth communication unit 306.

The authentication module 304 may be used to authenticate the user's identity based on the identity authentication information submitted by the user.

The authentication result transmission module 305 may be used to transmit the authentication result generated by the authentication module 304 to the authentication server 20.

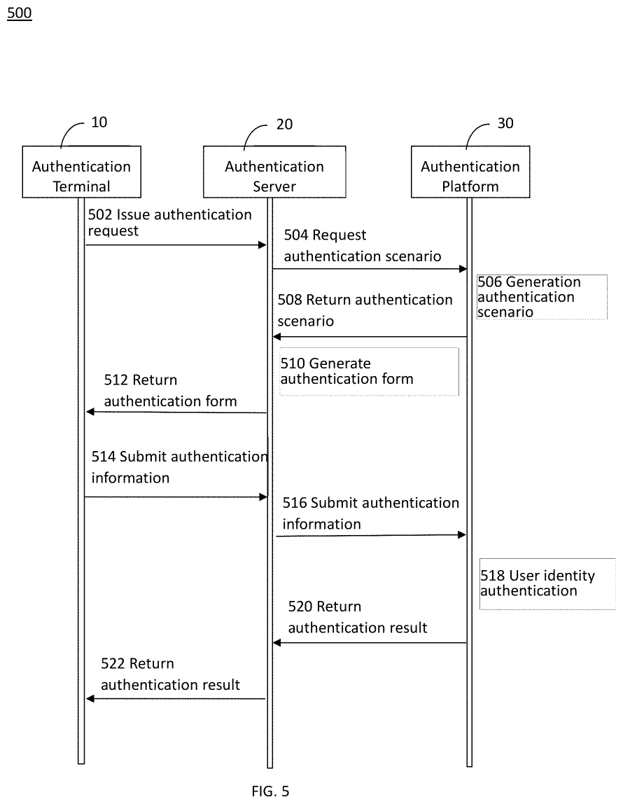

FIG. 5 is a flowchart of an identity authentication method 500 according to an embodiment of the present disclosure. In particular, the order of the steps in the flowchart may be changed based on different requirements, and some steps may be omitted or combined.

Step 502, the authentication terminal 10 may issue an authentication request based on a user operation. More specifically, in one embodiment, an authentication application may be installed on the authentication terminal 10. When the authentication application is turned on, the authentication request may be issued, or when an authentication process is triggered by clicking one or more buttons on the authentication application interface, the authentication request may be issued. In some embodiments, the authentication terminal 10 may also enter the authentication interface in the form of a webpage by using a predetermined web address, and when the authentication process is triggered by clicking one or more buttons on the authentication interface, the authentication request may be issued.

Step 504, the authentication server 20 may request the authentication platform to acquire an authentication scenario after receiving the authentication request.

A plurality of authentication scenarios are shown in FIG. 6 and FIG. 7. FIG. 6 illustrates a plurality of relatively simple authentication scenario images, and FIG. 7 illustrates a plurality of dynamic authentication scenario videos or a plurality of relatively complex authentication scenarios. In FIG. 6, the user may be holding an ID card. In particular, scene A may be an image of when the ID card is placed on the right side of the user's face; scene B may be an image of when the ID card is placed on the left side of the user's face; scene C may be an image of when the ID card is placed on top of the user's face; and scene D may be an image of when the ID is placed below the user's face. It may be understood that only a few positional relationships are shown here for exemplary purpose. In other embodiments, the ID card may have many other positional relationships with respect to the face, such as blocking a part of the face or at a specific distance from the face, and may also include images of other parts of the user other than the user's face. FIG. 7 is an authentication scenario in which the user is holding the ID card and moving it along a predetermined trajectory. For example, scene E in FIG. 7 shows the ID card being moved from top to bottom; scene F shows the ID card being placed on the left of the user's face and the user may be reading a predetermined passage; scene G shows the ID card being placed on the left of the user's face and the user may be shaking the head; and scene H shows the ID card being placed on the left of the user's face and a bottle being placed on the right of the user's face. It may be understood that FIG. 7 only shows four scenarios of E, F, G, and H for exemplary purposes. In other embodiments, many different scenarios may also be included. For example, the motion trajectory of the ID card may be other motion trajectories, for example, moving from left to right, moving from bottom to top, moving from right to left, moving along a predetermined arc, circle, or other curved shape, and the like. In addition, the user's face may move in a predetermined manner, such as shaking the head, nodding the head, turning the body, and the like. Further, the process may also be combined with a plurality of different audios, not limited to reading the predetermined passage as described in scene B, but also other audios such as singing a song. Furthermore, not limited to placing the bottle on the right side of the user's face as described in scene G, it may also be possible to place one or more other items on the side of the face or the like.

Step 506, the authentication platform 30 may randomly acquire one or more scenarios from the plurality of scenarios stored in the memory in advance. For example, the scenario may be a combination of a simple scene image and a scene video, or a single scene video.

Step 508, the authentication platform 30 may transmit the acquired one or more authentication scenarios to the authentication server 20.

Step 510, the authentication server 20 may generate an authentication form based on the received one or more authentication scenarios. The authentication form may include a plurality of fields, and the plurality of fields may include basic information such as a user name, gender, ID card information, and one or more received authentication scenarios.

Step 512, the authentication server 20 may transmit the generated authentication form to the authentication terminal 10.

Step 514, the authentication terminal 10 may display the authentication form on the display through the authentication interface for the user to input the corresponding identity authentication information, and transmit the identity authentication information inputted by the user to the authentication server 20. In particular, the user may input the required basic identity authentication through the input unit such as a keyboard or a touch screen, and take one or more required authentication scene images and videos by using an image acquisition device.

Step 516, the authentication server 20 may transmit the received identity authentication information to the authentication platform 30.

Step 518, the authentication platform 30 may perform the user identity authentication based on the identity authentication information submitted by the user. More specifically, for example, determine whether the user images in one or more scenes are consistent, and whether the user images in one or more authentication scenarios are consistent with the user ID card information.

Step 520, the authentication platform 30 may return an authentication result to the authentication server 20. The authentication result may include a successful authentication or an unsuccessful authentication. In some embodiments, the authentication result may further include a description of the reason of the unsuccessful authentication result, such as incorrect ID card information (e.g., an expired ID card) or a mismatch between the identity information and the scene image. In some embodiments, the authentication result may be stored in the third memory 307 of the authentication platform. When an authenticated user applies for authentication again, the authentication for the user may be completed by directly querying the stored authentication result.

Step 522, the authentication server 20 may return the authentication result to the authentication terminal 10. The authentication result may be transmitted to the authentication terminal 10 by using one or more methods such as a website information, a mobile phone text message, or a voice message to remind the user of the authentication result.

It may be understood that the identity authentication step 518 may also be performed directly in the authentication server 20. Further, the authentication server 20 may also store the authentication result to the second memory 208.

It may be understood that in other embodiments, the authentication server 20 and the authentication platform 30 may be integrated. The authentication server 20 may store a plurality of authentication scenarios, and the generation of the authentication scenario and the authentication of the identity may all be completed in the authentication server 20.

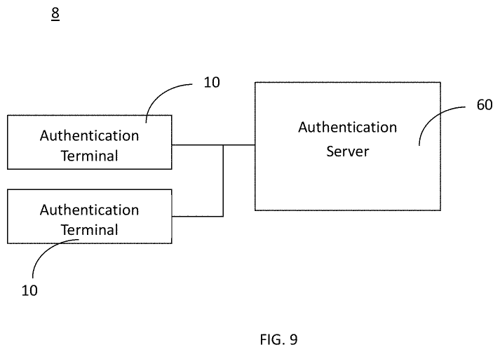

FIG. 9 is an identity authentication system 8 according to another embodiment of the present disclosure. The identity authentication system 8 may include, but is not limited to, one or more authentication terminals 10 and an authentication server 60. The authentication terminal 10 may be communicatively connected to the authentication server 60, and the authentication server 60 may be communicatively connected to the authentication platform 30. The authentication terminal may initiate an authentication process based on a user operation and issue an authentication request. Further, the authentication server 60 may acquire an authentication scenario from its storage unit based on the authentication request, generate an authentication form based on the authentication scenario, and transmit the authentication form to the authentication terminal 10. The authentication terminal 10 may receive the identity authentication information inputted by the user for the authentication form and transmit the identity authentication information to the authentication server 60. Furthermore, the authentication server 60 may authenticate the user identity based on the identity authentication information to generate an authentication result and return the authentication result to the authentication terminal 10.

In particular, the authentication terminal 10 may be the same as the authentication terminal 10 provided in the embodiment shown in FIG. 2, and details are not described herein.

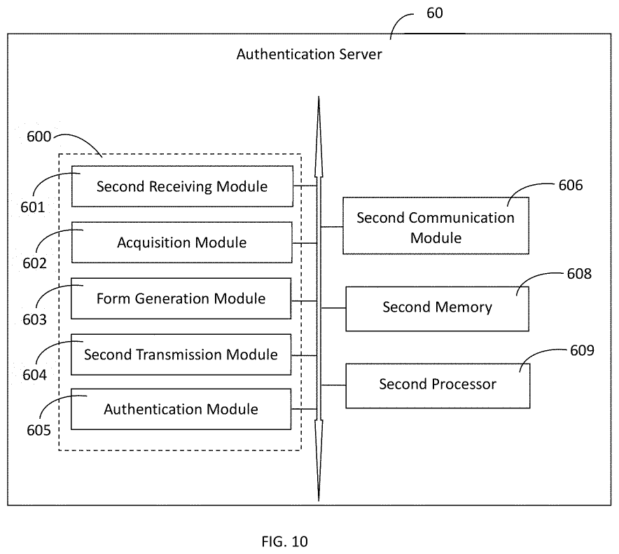

FIG. 10 is a modular diagram of an authentication server 60 according to another embodiment of the present disclosure. The authentication server 60 may include, but is not limited to, a second communication unit 606, a second memory 608, and a second processor 609. The second communication unit 606 may be a communication unit corresponding to the first communication unit 104 and may be a wired or a wireless communication unit. Further, the second communication unit 606 may be communicatively connected to the first communication unit 104 to facilitate communication between the authentication terminal 10 and the authentication server 60.

The second memory 608 may be an internal storage of the authentication server 60, for example, a hard disk or a memory. Or, the second memory 608 may be a plug-in storage device, such as a plug-in hard disk, a SMC, a SD card, and a flash card. Further, the second memory 608 may also include both the internal storage unit and the plug-in storage device.

The second processor 609 may be a Central Processing Unit (CPU), a microprocessor, or other data processing chip for performing the functions of the authentication server 60.

A second authentication system 600 may be installed and operated in the authentication server 60 and may include computer executable instructions in the form of one or more programs that may be executable by the second processor 609. The second authentication system 600 may also be integrated and fixed in the second processor 609, or it may be stored in the second memory 608 independently of the second processor 609. In the present embodiment, the second authentication system 600 may include, but is not limited to, a second receiving module 601, an acquisition module 602, a form generation module 603, a second transmission module 604, and an authentication module 605. The functional modules in the present disclosure may be referred to as a series of computer executable instructions that may be executed by the second processor 609 of the authentication server 60 to perform fixed functions. In particular, the series of computer executable instructions may be stored in the second memory 608.

The second receiving module 601 may be used to receive the authentication request and the identity authentication information from the authentication terminal 10 by using the second communication unit 606.

The acquisition module 602 may be used to acquire the authentication scenario from the second memory 608. For a detailed description of the authentication scenario, reference may be made to the description of FIG. 6 and FIG. 7.

The form generation module 603 may be used to generate an authentication form based on the acquired authentication scenario. The authentication form may include, but is not limited to, one or more authentication scenarios and scenario instances, where the scenario instances may be an example of an image or a video of a user in the authentication scenario, a basic user information, etc. The basic user information may include, but is not limited to, a name, a gender, and an ID card information.

The second transmission module 604 may be used to transit the generated authentication form to the authentication terminal 10 by using the second communication unit 606.

The authentication module 605 may be used to authenticate the user identity based on the user identity authentication information to generate an authentication result. The authentication result may include a successful authentication result or an unsuccessful authentication result. In some embodiments, the authentication result may further include a description of the reason of the unsuccessful authentication result, such as an expired ID card or a mismatch between the identity information and the scene image.

The second transmission module 604 may further be used to transmit the authentication result to the authentication terminal 10 by using the second communication unit 606. The authentication form and the authentication result may be displayed on the display 107 through the interface module 101 of the authentication terminal 10.

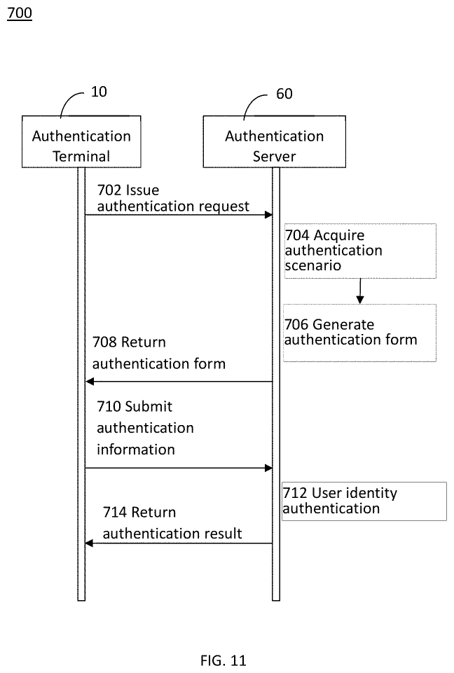

FIG. 11 is a flowchart of an identity authentication method 700 according to another embodiment of the present disclosure. In particular, the order of the steps in the flowchart may be changed based on different requirements, and some steps may be omitted or combined.

Step 702, the authentication terminal 10 issues an authentication request based on a user operation. More specifically, in one embodiment, an authentication application may be installed on the authentication terminal 10. When the authentication application is turned on, the authentication request may be issued, or when an authentication process is triggered by clicking one or more buttons on the authentication application interface, the authentication request may be issued. In some embodiments, the authentication terminal 10 may also enter the authentication interface in the form of a webpage by using a predetermined web address, and when the authentication process is triggered by clicking one or more buttons on the authentication interface, the authentication request may be issued.

Step 704, the authentication server 60 randomly may randomly acquire one or more scenarios from the plurality of scenarios stored in the second memory 608 in advance after receiving the authentication request. For example, the scenario may be a combination of a simple scene image and a scene video, or a single scene video

Step 706, the authentication server 60 may generate an authentication form based on the received one or more authentication scenarios. The authentication form may include a plurality of fields, and the plurality of fields may include basic information such as a user name, gender, ID card information, and one or more received authentication scenarios.

Step 708, the authentication server 60 may transmit the generated authentication form to the authentication terminal 10.

Step 710, the authentication terminal 10 may display the authentication form on the display through the authentication interface for the user to input the corresponding identity authentication information, and transmit the identity authentication information inputted by the user to the authentication server 60. In particular, the user may input the required basic identity authentication through the input unit such as a keyboard or a touch screen, and take one or more required authentication scene images and videos by using an image acquisition device.

Step 712, the authentication server 60 may perform the user identity authentication based on the identity authentication information submitted by the user to generate the authentication result. More specifically, for example, determine whether the user images in one or more scenes are consistent, and whether the user images in one or more authentication scenarios are consistent with the user ID information.

Step 714, the authentication server 60 may return the authentication result to the authentication terminal 10. The authentication result may be transmitted to the authentication terminal 10 by using one or more methods such as a website information, a mobile phone text message, or a voice message to remind the user of the authentication result.

It may be understood that the authentication terminal 10 may encrypt the identity authentication information before transmitting the identity authentication information to the authentication server 60.

It may be understood that the identity authentication information may adopt an encryption technology during the transmission process to facilitate secure transmission of the identity authentication information. Suitable encryption methods may include, but are not limited to, Internet key exchange, Internet Protocol Security (IPsec), Kerberos, Point-to-Point Protocol, Transport Layer Security (TLS), SSID, MAC ID filtering, Static IP Addressing, 802.11 security, Wired Equivalent Privacy (WEP), Wi-Fi Protected Access (WPA), WPA 2, Temporal Key Integrity Protocol (TKIP), Extensible Authentication Protocol, Lightweight Extensible Authentication Protocol (LEAP), Protected Extensible Authentication Protocol (PEAP), and other commercially available encryption methods.

It may be understood that the authentication platform 30 or the authentication server 60 may also be connected to an identity information system wirelessly or by wire to further verify the user's ID card information, such as a national ID card number query system.

It may be understood that the identity authentication system and method of the present disclosure can be applied to user identity authentication in various applications and scenarios requiring identity authentication in various fields and industries, such as finance, social security, public security, etc. Further, the present disclosure may perform the authentication by using a randomly generated scene, which is not a constant image authentication, thereby eliminating the use of other people's images for authentication and improving the security and reliability of the authentication

In addition, those skilled in the art can make various changes and variations to the present disclosure without departing from the spirit and scope of the present invention. Therefore, if these modifications and variations of the present disclosure belong to the scope of the claims of the present disclosure and the equivalent technology, the present disclosure is also intended to encompass these changes and variations.

What is claimed is:

1. An identity authentication system, comprising:
an authentication terminal configured to issue an identity authentication request; and,
an authentication server that is connected to the authentication terminal to receive the identity authentication request, configured to acquire one or more identity authentication scenarios from a plurality of authentication scenarios based on the identity authentication request, and generate and transmit an authentication form after acquiring the authentication scenario;
wherein the authentication terminal is configured to submit the identity authentication information to the authentication server based on the authentication form, the identity authentication information includes basic user information and an authentication scenario image and video including a user, and the authentication server is further configured to authenticate the user's identity based on the identity authentication information.

2. The system of claim 1, wherein the authentication scenario includes a video in which the user is reading a passage upon a request, or
wherein the authentication scenario includes a video in which the user is holding an
identification card and moving it relative to a face image of the user,

3. The system of claim 1, wherein the authentication scenario includes an image in which the identification card held by the user has a positional relationship with the face image of the user.

4. The system of claim 3, wherein the authentication scenario includes items other than the user's identification card and an image of the other items having a positional relationship with respect to an image of the user.

5. The system of claim 1, wherein the identity authentication information further includes an electronic signature or an electronic stamp of the user.

6. The system of claim 1, wherein the authentication server is connected to an identification card query system to authenticate the user's identification card information.

7. The system of claim 1, wherein the authentication terminal and the authentication server are communicatively connected by a fixed wire, Bluetooth, infrared, Wi-Fi, or a mobile communication network.

8. The system of claim 1, wherein the authentication terminal further performs an encryption processing on the identity authentication information before transmitting the identity authentication information.

9. The system of claim 1, wherein the identity authentication information is encrypted by using an encryption technique in the process of transmitting the identity authentication information to the authentication server.

10. An identity authentication method, comprising:
issuing, by an authentication terminal, an identity authentication request;
acquiring, by an authentication server, one or more authentication scenarios from a plurality of authentication scenarios based on the identity authentication information;
generating, by the authentication server, an identity authentication form based on the acquired identity authentication scenario;
transmitting, by the authentication server, the generated identity authentication form to the authentication terminal, the identity authentication form including a plurality of fields that include a basic user information field, and one or more acquired authentication scenarios;
submitting, by the authentication terminal, the identity authentication information to the identity authentication server based on the entity authentication form; and,
authenticating, by the identity authentication server, a user based on the identity authentication information to generate an authentication result.

11. The method of claim 10, wherein the authentication scenario includes a video in which the user is reading a passage upon a request, or
wherein the authentication scenario includes a video in which the user is holding an identification card and moving it relative to a face image of the user.

12. The method of claim 10, wherein the authentication scenario includes an image in which the identification card held by the user has a positional relationship with the face image of the user.

13. The method of claim 12, wherein the authentication scenario includes items other than the user's identification card and an image of the other items having a positional relationship with respect to an image of the user.

14. The method of claim 10, wherein the identity authentication information further includes an electronic signature or an electronic stamp of the user.

15. The method of claim 10, wherein the authentication terminal issues the identity authentication request by using an application installed on the authentication terminal.

16. The method of claim 10, wherein the authentication terminal accesses the identity authentication system through a web browser and issues the identity authentication request by triggering one or more buttons on an identity authentication interface provided by the identity authentication system.

17. The method of claim 10, wherein the authentication server is further connected to an identification card query system to authenticate the user's identification card information.

18. The method of claim 10, further comprising:
performing, by the authentication terminal, an encryption processing on the identity authentication information before transmitting the identity authentication information.

19. The method of claim 10, wherein the identity authentication information is encrypted by using an encryption technique in the process of transmitting the identity authentication information from the authentication terminal to the authentication server.
